(19) United States
(12) Patent Application Publication
(10) Pub. No.: US 2025/0333938 A1
(43) Pub. Date: Oct. 30, 2025

(54) SPRAYING MECHANISM AND WATER OUTLET DEVICE

(71) Applicant: XIAMEN SOLEX HIGH-TECH INDUSTRIES CO., LTD., XIAMEN (CN)

(72) Inventors: Zhijun WANG, Xiamen (CN); Zhichun LIN, Xiamen (CN); Shilong WU, Xiamen (CN); Qingxin FU, Xiamen (CN); Youxian HU, Xiamen (CN)

(21) Appl. No.: 18/924,093

(22) Filed: Oct. 23, 2024

(30) Foreign Application Priority Data
Apr. 30, 2024 (CN) 2024105436631

(51) Int. Cl. E03C 1/04; E03C 1/02

(52) U.S. Cl. CPC E03C 1/0408; E03C 1/0403; E03C 2001/026

(57) ABSTRACT

The disclosure provides a spraying mechanism and a water outlet device. The spraying mechanism comprises a water inlet assembly provided with a water inlet channel, a supporting arm assembly connected to the water inlet assembly and rotatable in respect to the water inlet assembly, and a first shower head communicated to the water inlet channel through the supporting arm assembly, connected to the supporting arm assembly and rotatable in respect to the supporting arm assembly. There is at least a first distance and a second distance between a projection of a connection position between the first shower head and the supporting arm assembly in respect to a reference plane perpendicular to the central axis of the first shower head and a projection of a central axis of the first shower head in respect to the reference plane, and the first distance is not equal to the second distance.

This application claims priority to Chinese Application No. 202410543663.1, entitled “spraying mechanism and water outlet device” and filed on Apr. 30, 2024, which is incorporated herein by reference in its entirety.

### TECHNICAL FIELD

The present disclosure generally relates to the field of bathroom techniques, and more particularly, to a spraying mechanism and a water outlet device.

### BACKGROUND

In the prior art, the top spray head of a shower assembly is usually arranged fixed, and the angle and height of the top spray head cannot be adjusted, resulting in a relatively singular shower mode, which cannot be adjusted according to actual requirements of users, and the experience of the users is poor.

### SUMMARY

The spraying mechanism and the water outlet device provided by the disclosure can provide diverse shower modes and improved user satisfaction.

According to a first aspect of the disclosure, there is provided a spraying mechanism comprising: a water inlet assembly, provided with a water inlet channel; a supporting arm assembly, connected to the water inlet assembly and rotatable in respect to the water inlet assembly; and a first shower head, communicated to the water inlet channel through the supporting arm assembly, the first shower head is connected to the supporting arm assembly and rotatable in respect to the supporting arm assembly, there is at least a first distance and a second distance between a projection of a connection position between the first shower head and the supporting arm assembly in respect to a reference plane and a projection of a central axis of the first shower head in respect to the reference plane, and the first distance is not equal to the second distance; wherein the reference plane is perpendicular to the central axis of the first shower head.

In some embodiments, when the first distance between a projection of a rotation center between the first shower head and the supporting arm assembly in respect to the reference plane and the projection of the central axis of the first shower head in respect to the reference plane is zero, the connection position between the first shower head and the supporting arm assembly is a first position; when a distance between the projection of the rotation center between the first shower head and the supporting arm assembly in respect to the reference plane and the projection of the central axis of the first shower head in respect to the reference plane is the second distance, the connection position between the first shower head and the supporting arm assembly is a second position; wherein a distance between the first position and the second position is less than or equal to a radius of the first shower head.

In some embodiments, the water inlet assembly comprises: a fixed seat, the supporting arm assembly is sheathed outside the fixed seat and rotatable in respect to the fixed seat, a circumferential side wall of the fixed seat is provided with a communication port, the water inlet channel is arranged in the fixed seat, and the water inlet channel is communicated to the supporting arm assembly through the communication port.

In some embodiments, the spraying mechanism further comprises a limiting assembly, and the limiting assembly is arranged between the fixed seat and the supporting arm assembly for position limiting between the fixed seat and the supporting arm assembly.

In some embodiments, the limiting assembly comprises an elastic member and a limiting member, one of an outer wall of the fixed seat and an inner wall of the supporting arm assembly is provided with an accommodating groove, and the other is provided with a plurality of limiting holes along a circumferential direction of the fixed seat, the elastic member is arranged in the accommodating groove, one end of the limiting member abuts against the elastic member and the other end is able to be arranged penetrating through one of the limiting holes.

In some embodiments, one side of the supporting arm assembly and the first shower head facing each other is provided with a first water outlet part, and the other side is provided with a first water outlet fitting part, the first water outlet part and the first water outlet fitting part are screwed connected, and the supporting arm assembly, the first water outlet part, the first water outlet fitting part, and the first shower head are communicated to each other.

In some embodiments, the first shower head comprises a first connecting assembly and a second connecting assembly, one end of one end of the first connecting assembly is connected to the supporting arm assembly and communicated to the supporting arm assembly, and the other end is connected to the second connecting assembly, and the second connecting assembly is rotatable in respect to the first connecting assembly.

In some embodiments, the first connecting assembly comprises: a mounting seat, at least partially arranged in the second connecting assembly, and the second connecting assembly is rotated in respect to the mounting seat; and a first connecting part, one end is connected to the supporting arm assembly, and the other end is arranged penetrating through the mounting seat and connected to the mounting seat, and the supporting arm assembly, the first connecting part, the mounting seat, and the second connecting assembly are communicated to each other.

In some embodiments, the first connecting assembly further comprises a fastener, a side of the mounting seat facing the supporting arm assembly is provided with a protrusion arranged protruding, and the fastener is sheathed outside the first connecting part and the protrusion and screwed connected to the protrusion.

In some embodiments, the first connecting assembly further comprises: a guiding member, one side of the second connecting assembly facing the supporting arm assembly is provided with a guiding hole, the guiding member is sheathed outside the mounting seat and is arranged in the guiding hole, the second connecting assembly is rotated in respect to the guiding member, and the guiding hole and the guiding member are cooperative in guiding.

In some embodiments, the guiding member has a cross section of circular structure, and the guiding hole is a circular through hole; and/or a projection of a central axis of the guiding member in respect to the reference plane and the projection of the central axis of the first shower head in respect to the reference plane are not coincident.

In some embodiments, a diameter of the guiding member is less than or equal to a diameter of the guiding hole; and/or the diameter of the guiding member is larger than a radius of the first shower head, and the diameter of the guiding member is smaller than a diameter of the first shower head.

In some embodiments, the second connecting assembly comprises: a shower head body, the mounting seat is at least partially arranged in the shower head body, the guiding hole is arranged in the shower head body, and the shower head body is rotated in respect to the guiding member; and a rainfall cover, located in the shower head body and connected to the shower head body, the rainfall cover is annularly arranged around the mounting seat, and the rainfall cover is rotated in respect to the mounting seat.

In some embodiments, one side of the rainfall cover and the mounting seat close to each other is provided with a limit hook, and the other side is provided with a limit clasp, the limit hook hooks onto the limit clasp, and the limit hook and the limit clasp are rotatable in respect to each other.

In some embodiments, the spraying mechanism further comprises: a wall seat; and
a second shower head, connected to the water inlet assembly and able to be communicated to the water inlet channel; wherein the second shower head is detachably connected to one of the water inlet assembly and the wall seat.

In some embodiments, the water inlet assembly comprises a fixed seat, the supporting arm assembly is sheathed outside the fixed seat and rotatable in respect to the fixed seat, and the water inlet channel is arranged in the fixed seat; wherein the fixed seat is provided with a first water outlet and second water outlet, the first water outlet is communicated to the supporting arm assembly, the second water outlet is communicated to the second shower head, and the water inlet channel is selectively communicated to the first water outlet and/or the second water outlet.

In some embodiments, the spraying mechanism further comprises a switching assembly, the switching assembly includes a switching shaft, and one end of the switching shaft is provided with a holding part, and the other end is provided with an obstructing part; and wherein the switching shaft is arranged penetrating through the fixed seat and rotated in respect to the fixed seat, such that the obstructing part is able to selectively obstruct the first water outlet and/or the second water outlet.

In some embodiments, the spraying mechanism further comprises a sealing member, the sealing member is arranged in the water inlet channel, and the sealing member is wrapped on at least part of the obstructing part and arranged between the obstructing part and the fixed seat; and the sealing member is provided with a first through hole and a second through hole, the first through hole is arranged corresponding to the first water outlet and communicated to the first water outlet, and the second through hole is arranged corresponding to the second water outlet and communicated to the second water outlet.

In some embodiments, the spraying mechanism further comprises a plug, the plug is arranged inside an end of the water inlet channel close to the supporting arm assembly.

In some embodiments, the supporting arm assembly comprises: a sleeve, sheathed outside the water inlet assembly and rotatable in respect to the water inlet assembly; and a supporting arm, one end of the supporting arm is connected to the sleeve and communicated to the water inlet channel, and the other end of the supporting arm is rotatably connected to the first shower head and communicated to the first shower head.

According to the second aspect of the disclosure, an embodiment of the disclosure also provides a water outlet device comprising the above spraying mechanism.

The disclosure has the following advantages or beneficial effects.

In the spraying mechanism and the water outlet device provided by the embodiments of the disclosure, since the supporting arm assembly and the water inlet assembly, and the first shower head and the supporting arm assembly are not arranged being fixed to each other, but movably arranged, so by rotating the supporting arm assembly in respect to the water inlet assembly, and rotating the first shower head in respect to the supporting arm assembly, the first shower head can have multiple positions to meet the need of the user for different shower positions.

Meanwhile, the distance between the connection position between the first shower head and the supporting arm assembly and the position of the central axis of the first shower head is not fixed, such that the distance between the edge of the first shower head and the connection position between the supporting arm assembly and the first shower head can be selected from two different distances, i.e., the first distance or the second distance, thereby adjusting the relative position of the first shower head in respect to the supporting arm assembly, and diversifying the shower modes to meet the diversified use requirements of users.

### BRIEF DESCRIPTION OF THE DRAWINGS

For a better understanding of the present disclosure, reference can be made to the embodiments shown in the following drawings. Components in the drawings are not necessarily to scale, and related members may be omitted in order to emphasize and clearly explain the technical features of the disclosure. In addition, related members or components may be arranged differently as known in the art. Furthermore, in the drawings, same reference numerals indicate same or similar parts in the various drawings. The above and other features and advantages of the disclosure will become more apparent by describing in detail exemplary embodiments thereof with reference to the accompanying drawings.

Among the drawings:

FIG. 1 shows a schematic structural view of a spraying mechanism according to a first embodiment of the disclosure;

FIG. 2 shows a sectional view of the spraying mechanism according to the first embodiment of the disclosure with a first shower head and a second shower head hidden;

FIG. 3a1 shows a first schematic view of the spraying mechanism according to the first embodiment of the disclosure in a first shower mode;

FIG. 3a2 shows a second schematic view of the spraying mechanism according to the first embodiment of the disclosure in the first shower mode;

FIG. 3a3 shows a second schematic view of the spraying mechanism according to the first embodiment of the disclosure in the first shower mode;

FIG. 3b1 shows a first schematic view of the spraying mechanism according to the first embodiment of the disclosure in a second shower mode;

FIG. 3b2 shows a second schematic view of the spraying mechanism according to the first embodiment of the disclosure in the second shower mode;

FIG. 3b3 shows a second schematic view of the spraying mechanism according to the first embodiment of the disclosure in the second shower mode;

FIG. 3c1 shows a first schematic view of the spraying mechanism according to the first embodiment of the disclosure in a third shower mode;

FIG. 3c2 shows a second schematic view of the spraying mechanism according to the first embodiment of the disclosure in the third shower mode;

FIG. 3c3 shows a schematic view of the spraying mechanism according to the first embodiment of the disclosure in the third shower mode second;

FIG. 3d1 shows a first schematic view of the spraying mechanism according to the first embodiment of the disclosure in a fourth shower mode;

FIG. 3d2 shows a second schematic view of the spraying mechanism according to the first embodiment of the disclosure in the fourth shower mode;

FIG. 3d3 shows a second schematic view of the spraying mechanism according to the first embodiment of the disclosure in the fourth shower mode;

FIG. 3e1 shows a first schematic view of the spraying mechanism according to the first embodiment of the disclosure in a fifth shower mode;

FIG. 3e2 shows a second schematic view of the spraying mechanism according to the first embodiment of the disclosure in the fifth shower mode;

FIG. 4 shows an exploded schematic view of the spraying mechanism according to the first embodiment of the disclosure;

FIG. 5 shows a sectional view of a water inlet assembly in the spraying mechanism according to the first embodiment of the disclosure;

FIG. 6 shows a schematic structural view of a fixed seat in the spraying mechanism according to the first embodiment of the disclosure;

FIG. 7a shows a first schematic structural view of e a water inlet assembly and a supporting arm assembly in the spraying mechanism according to the first embodiment of the disclosure;

FIG. 7b shows a sectional view takin at C-C in FIG. 7a;

FIG. 7c shows a schematic structural view showing a limiting assembly of the spraying mechanism according to the first embodiment of the disclosure;

FIG. 8 shows a second schematic structural view of the water inlet assembly and the supporting arm assembly in the spraying mechanism according to the first embodiment of the disclosure;

FIG. 9 shows a sectional view takin at B-B in FIG. 5;

FIG. 10a1 shows a first schematic view of the spraying mechanism according to the first embodiment of the disclosure showing a first water outlet having water flowing therein;

FIG. 10a2 shows a second schematic view of the spraying mechanism according to the first embodiment of the disclosure showing a first water outlet having water flowing therein;

FIG. 10b1 shows a first schematic view of the spraying mechanism according to the first embodiment of the disclosure showing both the first water outlet and a second water outlet having water flowing therein;

FIG. 10b2 shows a second schematic view of the spraying mechanism according to the first embodiment of the disclosure showing both the first water outlet and the second water outlet having water flowing therein;

FIG. 10c1 shows a first schematic view of the spraying mechanism according to the first embodiment of the disclosure showing the second water outlet having water flowing therein;

FIG. 10c2 shows a second schematic view of the spraying mechanism according to the first embodiment of the disclosure showing the second water outlet having water flowing therein;

FIG. 11 shows an exploded schematic view of the first shower head in the spraying mechanism according to the second embodiment of the disclosure;

FIG. 12 shows a sectional view of the first shower head in the spraying mechanism according to the second embodiment of the disclosure;

FIG. 13 shows a plan view of the first shower head in the spraying mechanism according to the second embodiment of the disclosure.

### DETAILED DESCRIPTION

Technical solutions in exemplary embodiments of the present the disclosure will be described clearly and completely by referring to the drawings corresponding to the exemplary embodiments of the disclosure. The example embodiments described herein are only for illustration purposes, and are not used to limit the scope of protection of the disclosure, so it should be understood, various modifications and changes can be made to the exemplary embodiments without departing from the scope of protection of the disclosure.

In the description of the disclosure, unless otherwise specified and limited, the terms “first” and “second” are only used for descriptive purposes and cannot be understood as indicating or implying relative importance, and the term “plural” refers to two or more; furthermore, the term “and/or” includes any and all combinations of one or more associated listed items. In particular, reference to “the/said” object or “an” object is also intended to indicate one of a possible plurality of such objects.

Unless otherwise specified or specified, the terms “connected” and “fixed” should be broadly understood. For example, “connected” can be fixedly connected, and can also be detachably connected, or integrally connected, electrically connected, signally connected; furthermore, “connected” can be directly connected, or be indirectly connected via an intermediary. For those skilled in the art, the specific meanings of the above terms in the disclosure can be understood based on specific situations.

Example embodiments will now be described more fully with reference to the accompanying drawings. However, the example embodiments can be embodied in various forms and should not be construed as limited to the embodiments set forth herein. On the contrary, these embodiments are provided such that the disclosure will be thorough and complete, and will fully supply the concepts of the example embodiments to those skilled in the art. Same reference numerals in the drawings indicate the same or similar structures, so their detailed description will be omitted.

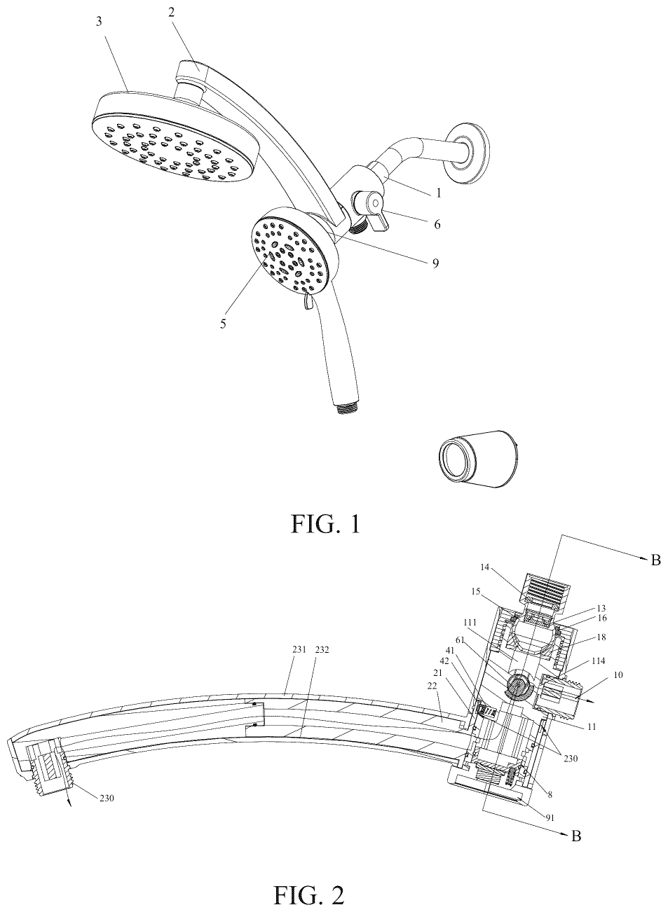

An embodiment of the disclosure provides a spraying mechanism suitable for the field of shower. As shown in FIGS. 1-2, the spraying mechanism comprises a water inlet assembly 1, a supporting arm assembly 2, and a first shower head 3. The water inlet assembly 1 is provided with a water inlet channel 111, the supporting arm assembly 2 is connected to the water inlet assembly 1 and can be rotated in respect to the water inlet assembly 1, and the first shower head 3 is communicated to the water inlet channel 111 through the supporting arm assembly 2, moreover, the first shower head 3 is connected to the supporting arm assembly 2 and can be rotated in respect to the supporting arm assembly 2.

The water inlet channel 111 of the water inlet assembly 1 is used for introducing spray water, and the spray water flowing out of the water inlet channel 111 enters the first shower head 3 through the supporting arm assembly 2 for spraying spray water by the first shower head 3. Since the supporting arm assembly 2 and the water inlet assembly 1, and the first shower head 3 and the supporting arm assembly 2 as well, are arranged movable in respect to each other, rather than fixed, by arranging the supporting arm assembly 2 rotatable in respect to the water inlet assembly 1, and arranging the first shower head 3 rotatable in respect to the supporting arm assembly 2, the first shower head 3 may be disposed at multiple positions, so to meet the requirements of users for different shower positions.

Among them, the first shower head 3 may also be called a rainfall shower head, and the supporting arm assembly 2 plays a role of communication between the water inlet assembly 1 and the first shower head 3, and provides a distance between the first shower head 3 and the water inlet assembly 1, thus increasing shower space for users. The first shower head 3 is shaped similar to a disc-shaped structure, and the plane where atop surface of the first shower head 3 is located is defined as a reference plane. Among them, the reference plane is perpendicular to a central axis of the first shower head 3.

If the connection position between the supporting arm assembly 2 and the first shower head 3 is just at the central position of the first shower head 3, then the distance between an edge of the first shower head 3 and the connection position between the supporting arm assembly 2 and the first shower head 3 remains unchanged, and the adjustment mode is relatively singular.

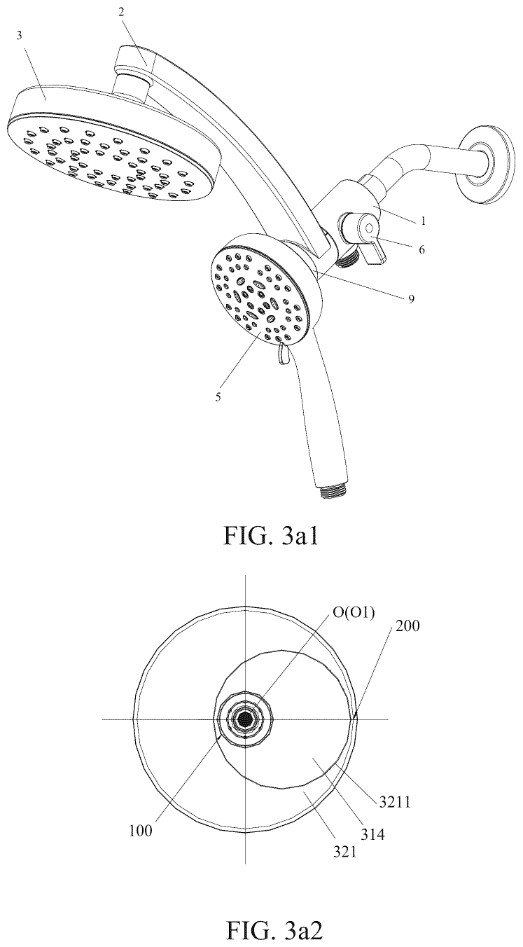

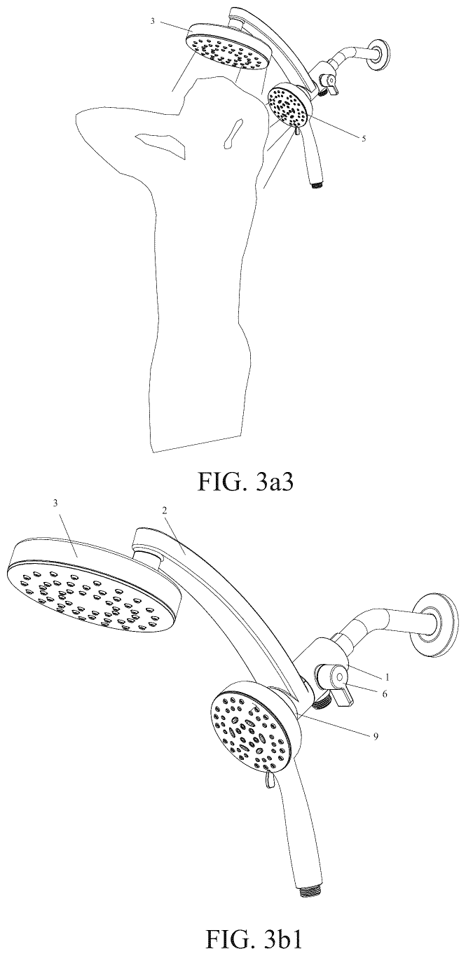

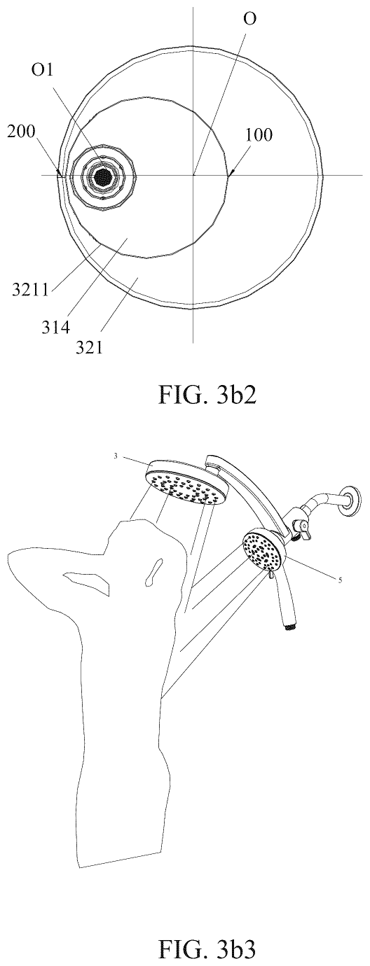

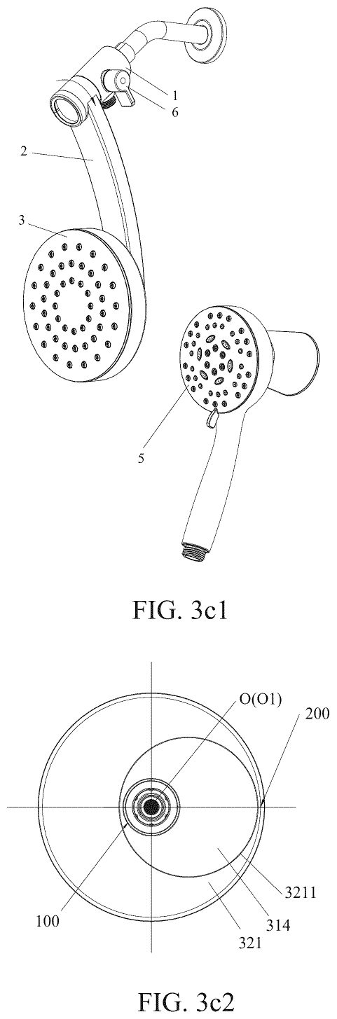

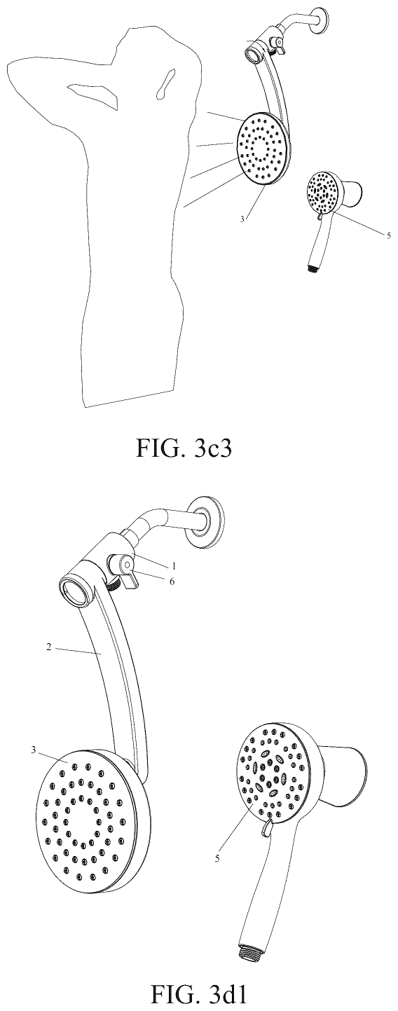

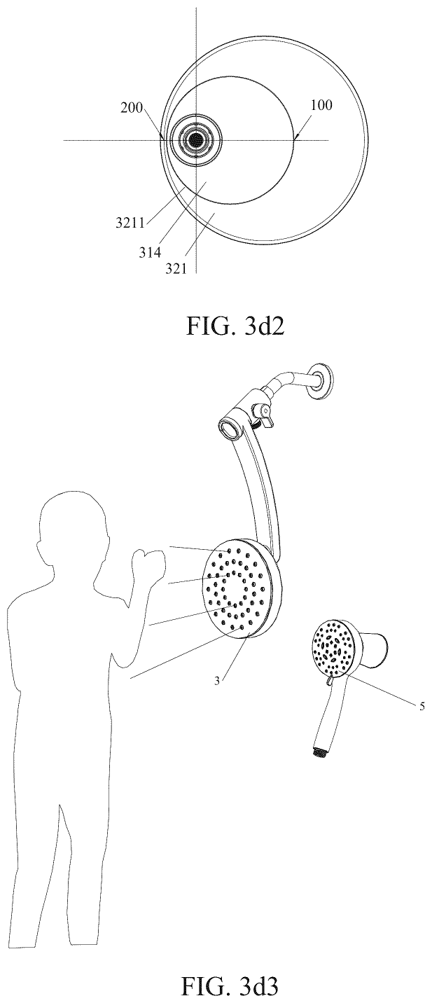

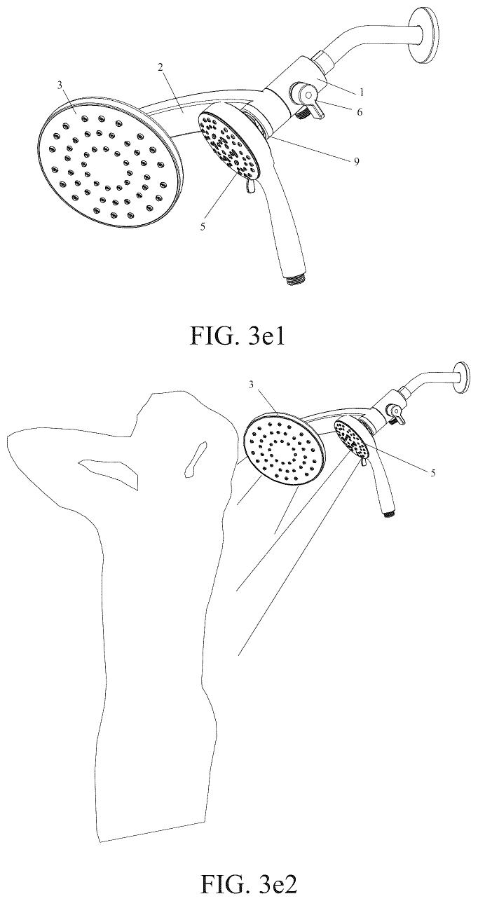

In order to solve the above problem, as shown in FIGS. 3a1-3e2, according to this embodiment, there are at least a first distance and a second distance between a projection of the connection position between the first shower head 3 and the supporting arm assembly 2 in respect to the reference plane and a projection of the central axis of the first shower head 3 in respect to the reference plane, and the first distance is not equal to the second distance. Among them, the projection of the connection position between the first shower head 3 and the supporting arm assembly 2 in respect to the reference plane is O1, and the projection of the central axis of the first shower head 3 in respect to the reference plane is O.

That is, the distance between the connection position between the first shower head 3 and the supporting arm assembly 2 and the position of the central axis of the first shower head 3 is not fixed, then the distance between the edge of the first shower head 3 and the connection position between the supporting arm assembly 2 and the first shower head 3 can be selected from two different distances, i.e., the first distance or the second distance, thereby adjusting the relative position of the first shower head 3 in respect to the supporting arm assembly 2, such that the shower mode can be diversified to meet the diversified use requirements of users.

Specifically, as shown in FIGS. 3a1-3a2, when the first distance between the projection of the rotation center between the first shower head 3 and the supporting arm assembly 2 in respect to the reference plane and the projection of the central axis of the first shower head 3 in respect to the reference plane is zero, the connection position between the first shower head 3 and the supporting arm assembly 2 is a first position 100.

At this time, the projection O1 of the connection position between the first shower head 3 and the supporting arm assembly 2 in respect to the reference plane and the projection O of the central axis of the first shower head 3 in respect to the reference plane are approximately coincident, that is, the connection position between the first shower head 3 and the supporting arm assembly 2 is just the central position of the first shower head 3, which are correspondingly arranged concentrically, and the distance between the edge of the first shower head 3 and the projection O1 is equal, and shower uniformity is good. At this time, the shower spraying mechanism is operated in a first shower mode.

Specifically, as shown in FIGS. 3b1-3b2, when the distance between the projection of the rotation center between the first shower head 3 and the supporting arm assembly 2 in respect to the reference plane and the projection of the central axis of the first shower head 3 in respect to the reference plane is a second distance, the connection position between the first shower head 3 and the supporting arm assembly 2 is a second position 200.

At this time, the projection O1 of the connection position between the first shower head 3 and the supporting arm assembly 2 in respect to the reference plane and the projection O of the central axis of the first shower head 3 in respect to the reference plane are not coincident, that is, the connection position between the first shower head 3 and the supporting arm assembly 2 is not the central position of the first shower head 3, both of them are eccentrically arranged, and the distance between the edge of the first shower head 3 and the projection O1 is not equal. At this time, the spraying mechanism is operated in a second shower mode.

It can be understood, an inner side part of the first shower head 3 facing the supporting arm assembly 2 is located below the supporting arm assembly 2. Since the distance between the inner side part and the water inlet assembly 1 is relatively small, the user's shower space is relatively narrow, which is not beneficial to shower experience. The inner side part may be called a dead angle part since it cannot be fully utilized. When the second shower mode is adopted, the projection O1 of the connection position between the first shower head 3 and the supporting arm assembly 2 in respect to the reference plane may be located in front, left or right of the projection O of the central axis of the first shower head 3 in respect to the reference plane, that is, the first shower head 3 is corresponding to the water inlet assembly 1 being arranged projected forward, leftward and rightward, which can, under the condition that the cross section of the first shower head 3 is constant, effectively reduce the area of the inner side part, reduce the dead angle part, and increase effective shower area, so as to increase effective shower space and improve shower experience even under the condition that the shower space is relatively narrow.

The spraying mechanism provided by this embodiment comprises at least a first shower mode and a second shower mode, so the shower modes are abundant, and the two shower modes can be switched by rotating the first shower head 3, so the modes can be switched freely and conveniently.

Among them, the distance between the first position 100 and the second position 200 is less than or equal to the radius of the first shower head 3.

In this way, the connection position between the first shower head 3 and the supporting arm assembly 2 will not exceed out of the range of the edge of the first shower head 3, which ensures the reliability of use, while in the second shower mode, the second distance can be selected to be any value smaller than the radius of the first shower head 3, that is, there is only one first position 100, and there can be a plurality of second positions 200, furthermore, the plurality of second positions 200 are circumferentially arranged around the first position 100, so as to increase the user's adjustable range of the first shower head 3 in respect to the supporting arm assembly 2.

In an embodiment, as shown FIGS. 3a1-3e2, the spraying mechanism further comprises a second shower head 5. Among them, the second shower head 5 may also be called a hand-held shower head, and the second shower head 5 is connected to the water inlet assembly 1 and can be communicated to the water inlet channel 111.

Among them, the spraying mechanism further comprises a wall seat, and the second shower head 5 is detachably connected to one of the water inlet assembly 1 and the wall seat.

Exemplarily, the second shower head 5 and the water inlet assembly I can be connected to each other in a detachable way such as magnetic attraction, clamping, adsorption, etc., which is convenient for users to hang or take the second shower head 5 on/from the water inlet assembly 1; moreover, the second shower head 5 and the wall seat can be connected to each other in a detachable way such as magnetic attraction, clamping, adsorption, etc., which is convenient for users to hang or take the second shower head 5 on/from the wall seat. Of course, it can be understood, the second shower head 5 can be directly hung/taken on/from a wall body, alternatively, the wall seat can be disposed on a wall, and the second shower head 5 can be hung/taken on/from the wall seat.

As shown in FIGS. 3al-3a3, when the spraying mechanism needs to be switched to the first shower mode, the supporting arm assembly 2 may bring the first shower head 3 to be rotated to directly upper ahead in respect to the water inlet assembly 1, the connection position between the first shower head 3 and the supporting arm assembly 2 is adjusted to the first position 100, and the second shower head 5 is hung on the water inlet assembly 1 for spraying the user's upper and rear parts such as head and shoulders.

As shown in FIGS. 3b1-3b3, when the spraying mechanism needs to be switched to the second shower mode, the supporting arm assembly 2 may bring the first shower head 3 to be rotated to directly upper ahead in respect to the water inlet assembly 1, the connection position between the first shower head 3 and the supporting arm assembly 2 is adjusted to the second position 200, and the second shower head 5 is hung on the water inlet assembly 1 for spraying the user's parts such as head, shoulders, back, etc.

As shown in FIGS. 3c1-3c3, when the spraying mechanism needs to be switched to the third shower mode, the supporting arm assembly 2 may bring the first shower head 3 to be rotated to directly below in respect to the water inlet assembly 1, the connection position between the first shower head 3 and the supporting arm assembly 2 is adjusted to the first position 100, and the second shower head 5 is hung on the wall seat for spraying the user's parts such as shoulders, back, etc.

As shown in FIGS. 3d1-3d3, when the spraying mechanism needs to be switched to the fourth shower mode, the supporting arm assembly 2 may bring the first shower head 3 to be rotated to directly below in respect to the water inlet assembly 1, the connection position between the first shower head 3 and the supporting arm assembly 2 is adjusted to the second position 200, and the second shower head 5 is hung on the wall seat for spraying the user's parts such as shoulders, back or chest, etc.

As shown in FIGS. 3e1-3e2, when the spraying mechanism needs to be switched to the fifth shower mode, the supporting arm assembly 2 may bring the first shower head 3 to be rotated to at least one of the left and right sides of the water inlet assembly 1 in respect to the water inlet assembly 1, the connection position between the first shower head 3 and the supporting arm assembly 2 is adjusted to the first position 100 or the second position 200, and the second shower head 5 is hung on the wall seat or the water inlet assembly 1 for spraying the user's parts such as sides, shoulders, neck, and back, etc.

Under mutual cooperation of the first shower head 3 and the second shower head 5, the spraying mechanism is operated in five shower modes, thereby increasing shower modes and improving the user's shower comfort.

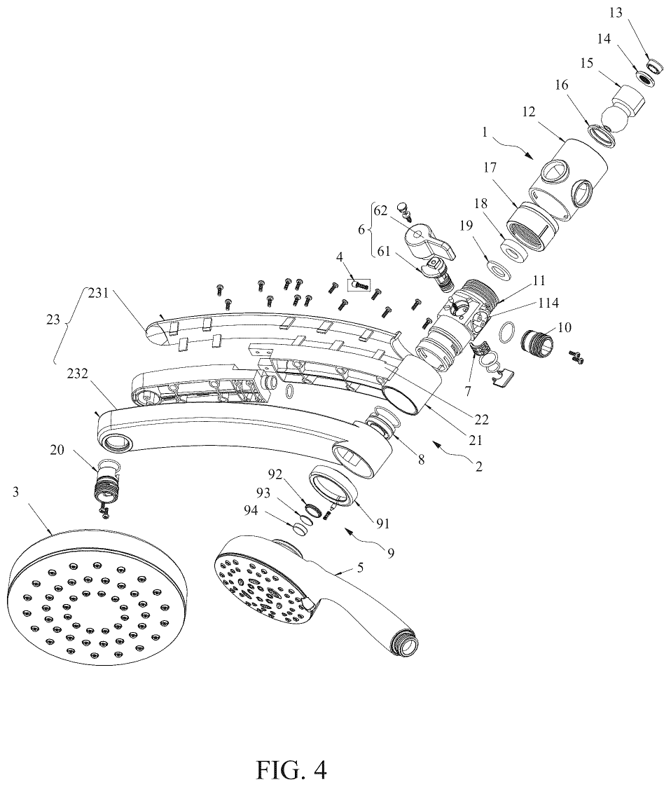

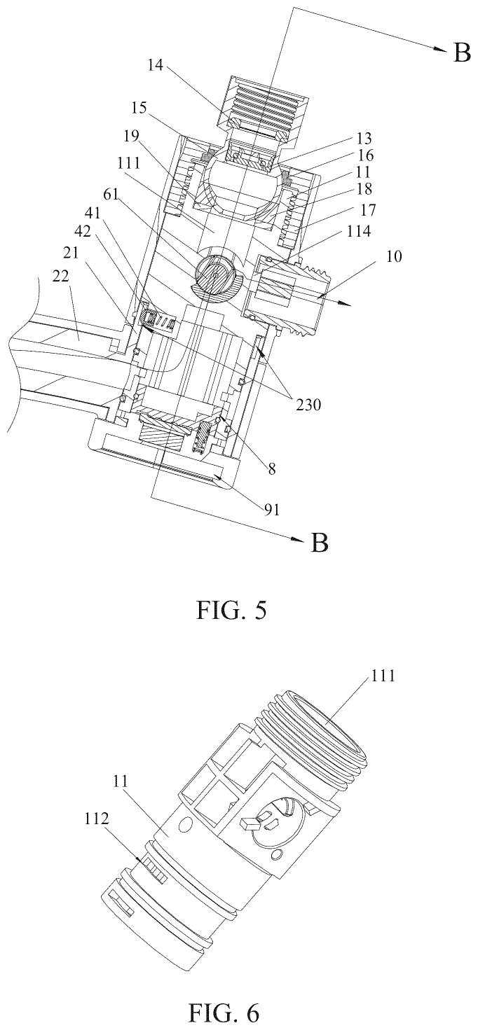

In an embodiment, as shown in FIGS. 4-5, the water inlet assembly 1 includes a fixed seat 11, a fixed body 12, a water-saving sheet 13, a screen gasket 14, a spherical joint 15, and a bushing 16. The spherical joint 15 is arranged penetrating through the top of the fixed seat 11, the spherical joint 15 and the fixed seat 11 are fixed to each other by a nut 17, and the spherical joint 15 is communicated to the water inlet channel 111 for supplying spray water to the water inlet channel 111. A side of the spherical joint 15 away from the fixed seat 11 is provided with a screen gasket 14 which plays a role of sealing and filtering. The bushing 16 is sheathed outside the spherical joint 15 and arranged between the spherical joint 15 and the nut 17 for reducing frictional resistance of the spherical joint 15 during rotation. A water-saving sheet 13 is arranged on a side of the spherical joint 15 close to the fixed seat 11, and plays a role in regulating flow rate. In addition, a spherical sealing gasket 18 is fit with the contour shape of the outer wall of the spherical joint 15, and the spherical sealing gasket 18 is arranged between the spherical joint 15 and the inner wall of the fixed seat 11 for sealing between the spherical joint 15 and the fixed seat 11. A first spacer 19 is arranged between the spherical scaling gasket 18 and a step of the fixed seat 11, and plays a role of position adjustment.

In an embodiment, the fixed seat 11 of the water inlet assembly 1 is arranged in the fixed body 12 which plays a role of protecting the fixed seat 11. The supporting arm assembly 2 is sheathed outside the fixed seat 11 and can be rotated in respect to the fixed seat 11, and the fixed seat 11 provides a rotation center for the supporting arm assembly 2.

As shown in FIGS. 5-6, a circumferential side wall of the fixed seat 11 is provided with a communication port 112, the water inlet channel 111 is arranged in the fixed seat 11, and the water inlet channel 111 is communicated to the supporting arm assembly 2 through the communication port 112. With such arrangement, even if the supporting arm assembly 2 is rotated in respect to the fixed seat 11, communication between the water inlet channel 111 and the supporting arm assembly 2 will not be affected since the communication port 112 is arranged on the circumferential side wall of the fixed seat 11, such that the supporting arm assembly 2 will not affect water supply to the first shower head 3 during the rotation.

Among them, a sealing ring is arranged between the circumferential side wall of the fixed seat 11 and the supporting arm assembly 2. The sealing ring can increase rotation force of the supporting arm assembly 2 around the fixed seat 11, and ensure sealing effect between the supporting arm assembly 2 and the fixed seat 11.

If there is no positioning or locking structure between the supporting arm assembly 2 and the fixed seat 11 during rotation of the supporting arm assembly 2 in respect to the fixed seat 11, then stability of adjusting the supporting arm assembly 2 in place cannot be ensured, and there may be a risk that the supporting arm assembly 2 or the first shower head 3 will fall when the user uses it.

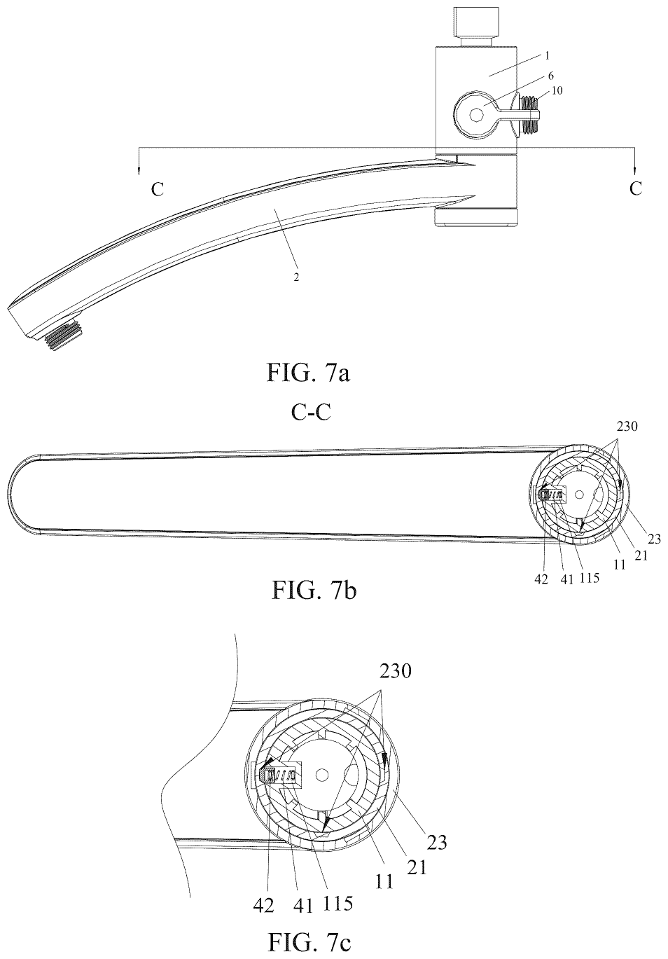

In order to solve this problem, as shown in FIGS. 7a-7c, the spraying mechanism further comprises a limiting assembly 4. The limiting assembly 4 is arranged between the fixed seat 11 and the supporting arm assembly 2 for position limiting between the fixed seat 11 and the supporting arm assembly 2.

When the supporting arm assembly 2 is rotated a preset position (the preset position is corresponding to different spraying modes) in respect to the fixed seat 11, the limiting assembly 4 can be used to perform position limiting between the supporting arm assembly 2 and the fixed seat 11, so as to ensure stability of the supporting arm assembly 2 at the current preset position and reduce the risk of the supporting arm assembly 2 or the first shower head 3 falling down.

Specifically, the limiting assembly 4 includes an elastic member 41 and a limiting member 42. One of an outer wall of the fixed seat 11 and an inner wall of the supporting arm assembly 2 is provided with an accommodating groove 115, and the other is provided with a plurality of limiting holes 230 along a circumferential direction of the fixed seat 11. The clastic member 41 is arranged in the accommodating groove 115, and one end of the limiting member 42 abuts against the elastic member 41 and the other end can be arranged penetrating through one of the limiting holes 230.

For example, in the case that the outer wall of the fixed seat 11 is provided with accommodating groove 115, and the inner wall of the supporting arm assembly 2 is provided with a plurality of limiting holes 230 along the circumferential direction of the fixed seat 11, the elastic member 41 can be selected as a spring, and the limiting member 42 can be selected as a positioning pin. The elastic member 41 is arranged between the limiting member 42 and a groove bottom of the accommodating groove 115, and the elastic member 41 can provide a certain elastic force for the limiting member 42.

When the supporting arm assembly 2 is rotated in respect to the fixed seat 11, if the limiting hole 230 and the accommodating groove 115 are not corresponding to each other, a side wall of the supporting arm assembly 2 abuts against the limiting member 42 and pushes the limiting member 42 to move in the direction close to the fixed seat 11, and the limiting member 42 compresses the elastic member 41; otherwise, if the limiting hole 230 and the accommodating groove 115 are corresponding to each other, under the elastic force of the compressed elastic member 41, the elastic member 41 makes the limiting member 42 move in the direction close to the limiting hole 230 until the limiting member 42 is inserted into the limiting hole 230. The limiting member 42 may generate a prompt sound once upon being inserted into the limiting hole 230, which can be used to judge whether the supporting arm assembly 2 is rotated in place for facilitating the user.

In this way, the limiting assembly 4 will not limit and affect rotation of the supporting arm assembly 2, and when the supporting arm assembly 2 is rotated to the preset position, the limiting assembly 4 can also perform position limiting to the supporting arm assembly 2 and the fixed seat 11, so as to play a role of locking the preset position, thus ensuring stability and reliability of the preset position.

It can be understood that this embodiment does not limit the number of the limiting holes 230. Moreover, the number of the limiting holes 230 can be correspondingly selected according to the required rotation angle each time.

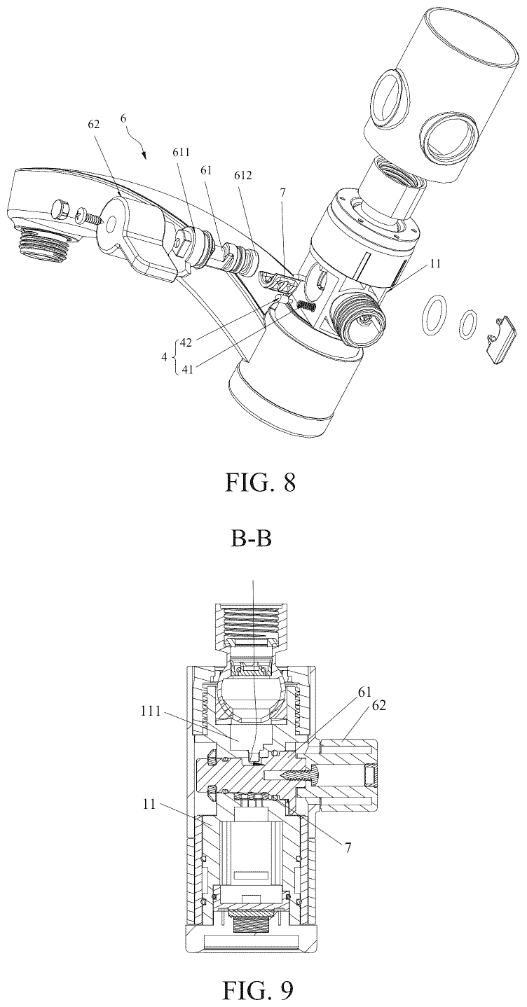

In an embodiment, as shown in FIGS. 8, 9 and 10a1-10c2, the fixed seat 11 is provided with a first water outlet 113 and a second water outlet 114. The first water outlet 113 is communicated to the supporting arm assembly 2, the second water outlet 114 is communicated to the second shower head 5 through a shower joint 10, and the water inlet channel 111 is selectively communicated to at least one of the first water outlet 113 and the second water outlet 114.

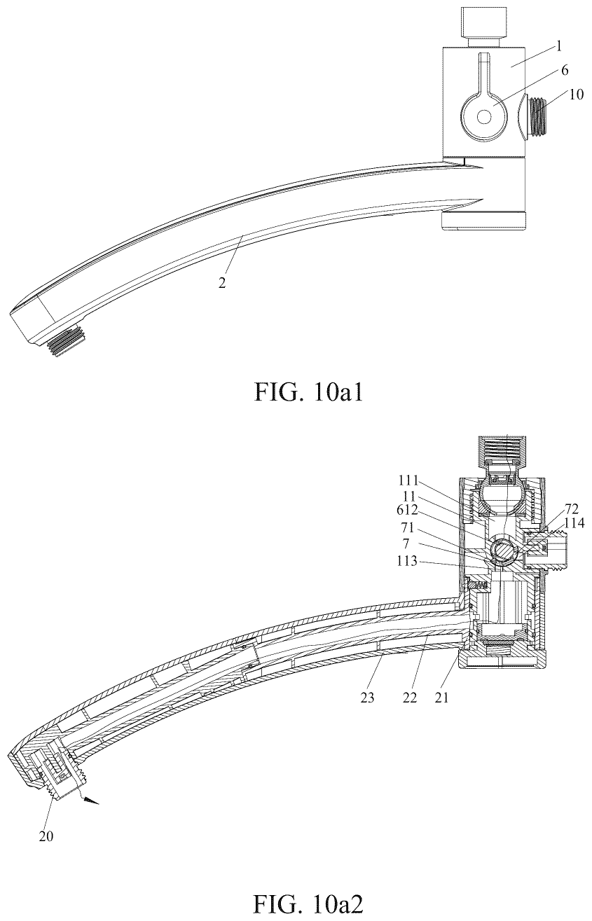

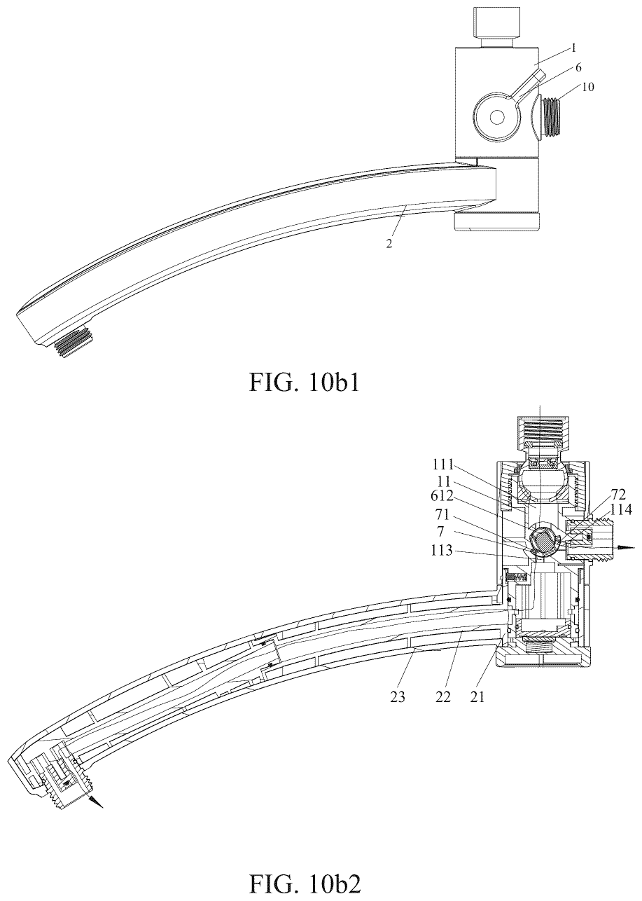

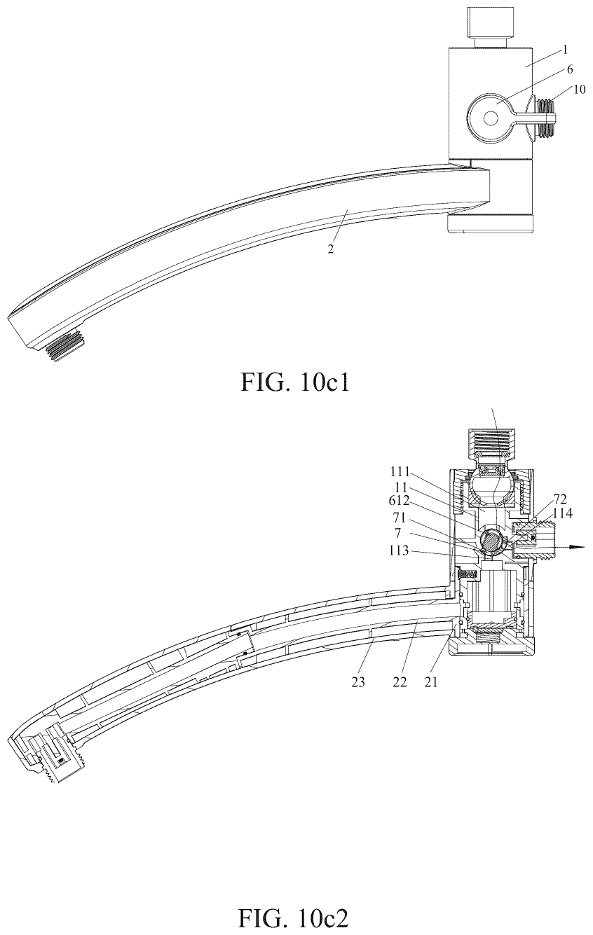

Exemplarily, as shown in FIGS. 10al-10a2, the water inlet channel 111 can be only communicated to the first water outlet 113, and the water inlet channel 111 supplies spray water to the first shower head 3 through the first water outlet 113 and the communication port 112 of the fixed seat 11, and the supporting arm assembly 2, such that the first shower head 3 operates to spray. As shown in FIGS. 10b1-10b2, the water inlet channel 111 can be communicated to the first water outlet 113 and the second water outlet 114 at the same time, and the first shower head 3 and the second shower head 5 can operate to spray at the same time. As shown in FIG. 10c1-10c2, the water inlet channel 111 can be only communicated to the second water outlet 114, and the water inlet channel 111 supplies spray water to the second shower head 5 through the second water outlet 114, such that the second shower head 5 operates to spray.

Furthermore, in some other embodiments, the water inlet channel 111 may not be communicated to the first water outlet 113 and the second water outlet 114 at the same time, and the first shower head 3 and the second shower head 5 may not operate to spray at the same time, that is, the spraying mechanism is in a non-operating state.

In this way, the first shower head 3 and the second shower head 5 share the same fixed seat 11, and the fixed seat 11 substantively plays a role of distributing water by making the first water outlet 113 and the second water outlet 114 corresponding to the first shower head 3 and the second shower head 5 respectively, such that the water channels for supplying spray water of the first shower head 3 and the second shower head 5 are independent from each other and do not affect each other, even if one of the first shower head 3 and the second shower head 5 fails, the other one can still be used normally, so as to achieve good standby effect.

In an embodiment, as shown in FIGS. 8-9, the spraying mechanism further comprises a switching assembly 6. The switching assembly 6 includes a switching shaft 61. One end of the switching shaft 61 is provided with a holding part 611, and the other end is provided with a obstructing part 612. Among them, the switching shaft 61 is arranged penetrating through the fixed seat 11 and rotatable in respect to the fixed seat 11, such that the obstructing part 612 can selectively obstruct the first water outlet 113 and/or the second water outlet 114.

When in use, the operator may operate the holding part 611 to rotate the switching shaft 61 in respect to the fixed seat 11. When the obstructing part 612 obstructs the second water outlet 114, the first water outlet 113 is in open state, the spray water is supplied to the first shower head 3 through the supporting arm assembly 2. When the obstructing part 612 is located between the first water outlet 113 and the second water outlet 114, both the first water outlet 113 and the second water outlet 114 are in open state, the spray water is supplied to the first shower head 3 through the supporting arm assembly 2, and the spray water flowing out from the second water outlet 114 is supplied to the second shower head 5. When the obstructing part 612 obstructs the first water outlet 113, the second water outlet 114 is in open state, and the spray water is supplied to the second shower head 5.

In an embodiment, as shown in FIGS. 8-9, the switching assembly 6 further includes a handle 62. The handle 62 is arranged on the holding part 611, so as to facilitate the to operate the switching shaft 61 by using the handle 62.

In an embodiment, as shown in FIGS. 8-9, the spraying mechanism further comprises a sealing member 7. The sealing member 7 may be embodied as a sealing gasket having an arc structure. The inner side face of the sealing member 7 and the outer wall of the obstructing part 612 of the switching shaft 61 are fit to each other in shape. The outer side face of the sealing member 7 and the inner wall of the water inlet channel 111 are fit to each other in shape. The sealing member 7 is arranged in the water inlet channel 111. The sealing member 7 is wrapped on at least part of the obstructing part 612 and is arranged between the obstructing part 612 and the fixed seat 11. In this way, sealing effect between the switching shaft 61 and the water inlet channel 111 of the fixed seat 11 is ensured during rotation switching of the switching shaft 61.

Among them, as shown in FIGS. 10al-10c2, the sealing member 7 is provided with a first through hole 71 and a second through hole 72. The first through hole 71 is arranged corresponding to the first water outlet 113 and communicated to the first water outlet 113, and the second through hole 72 is arranged corresponding to the second water outlet 114 and communicated to the second water outlet 114.

That is, the sealing member 7 does not obstruct the first water outlet 113 and the second water outlet 114, and the first through hole 71 and the second through hole 72 of the sealing member 7 are correspondingly communicated to the first water outlet 113 and the second water outlet 114, so as to ensure sealing between the switching shaft 61 and the water inlet channel 111 without affecting water outflowing of the first water outlet 113 and the second water outlet 114 at the same time.

In an embodiment, as shown in FIGS. 4-5, the spraying mechanism further comprises a plug 8, and the plug 8 is arranged inside an end of the water inlet channel 111 close to the supporting arm assembly 2. That is, the upper end of the water inlet channel 111 is used for introducing spray water, and the plug 8 obstructs the lower end of the water inlet channel 111 to prevent spray water from being directly discharged from the lower end of the water inlet channel 111, ensuring that spray water can effectively enter the supporting arm assembly 2.

It should be particularly noted, when the water inlet channel 111 is actually processed in the fixed seat 11, the water inlet channel 111 does not need to penetrate through the fixed seat 11, then it is not required obstruct the plug 8 in the water inlet channel 111; the water inlet channel 111 can penetrate through the fixed seat 11, so as to facilitate directly processing the water inlet channel 111 in the fixed seat 11 with relatively low process difficulty, then it is necessary to obstruct the plug 8 in the water inlet channel 111 at this time.

In an embodiment, as shown in FIGS. 4-5, the end of the fixed seat 11 facing the supporting arm assembly 2 is provided with a magnetic attraction assembly 9. The second shower head 5 can be directly attracted by using the magnetic attraction assembly 9, so as to facilitate hanging and/or taking the second shower head 5. Specifically, the magnetic attraction assembly 9 includes a magnet bracket 91, a cushion block 92, a second spacer 93, and a magnetic attraction member 94. The magnet bracket 91 is arranged in the fixed seat 11, and the magnet bracket 91 is used for installing the magnetic attraction member 94 which is made of a magnet material. The cushion block 92 and/or the second spacer 93 are arranged between the magnet bracket 91 and the magnetic attraction member 94 for adjusting position of the magnetic attraction member 94.

In an embodiment, as shown in FIGS. 4-5, the supporting arm assembly 2 includes a sleeve 21 and a supporting arm 22. The sleeve 21 is sheathed outside the water inlet assembly 1 and can be rotated in respect to the water inlet assembly 1. One end of the supporting arm 22 is connected to the sleeve 21 and communicated to the water inlet channel 111, and the other end of the supporting arm 22 is rotatably connected to the first shower head 3 and communicated to the first shower head 3.

Specifically, the sleeve 21 is sheathed outside the fixed seat 11 of the water inlet assembly 1, and the sleeve 21 can be rotated in respect to the fixed seat 11 while protecting the fixed seat 11. Since the supporting arm 22 is located between the sleeve 21 and the first shower head 3, the supporting arm 22 realizes intermediate connection and communication between the fixed seat 11 and the first shower head 3.

Among them, the supporting arm 22 may have an integral structure or a split structure. For example, the supporting arm 22 includes a plurality of interconnected monolithic bodies, and one of the monolithic bodies is connected to the sleeve 21 to be integrally formed with the sleeve 21, and then the monolithic body is connected to other monolithic bodies by bolts. Such sectional connection mode can be adopted to facilitate installation of the supporting arm 22.

In an embodiment, as shown in FIGS. 4-5, the supporting arm assembly 2 further includes a housing 23, and the sleeve 21 and the supporting arm 22 are arranged in the housing 23. An inner cavity of the housing 23 is used for accommodating the supporting arm 22 and the sleeve 21, so as to play a role of protecting the supporting arm 22 and the sleeve 21. The first shower head 3 may be installed on the housing 23. It can be understood, there may be a first flow channel inside the supporting arm 22, or a first flow channel is arranged between the housing 23 and the supporting arm 22, and the first flow channel is respectively communicated to the fixed seat 11 and the first shower head 3.

Among them, the housing 23 may comprise a first housing 231 and a second housing 232 arranged up and down. The first housing 231 and the second housing 232 are interlocked with each other and connected to each other by bolts, so as to facilitate installation and disassembly.

In an embodiment, one side of the supporting arm assembly 2 and the first shower head 3 facing each other is provided with a first water outlet part 20, and the other is provided with a first water outlet fitting part (not shown), the first water outlet part 20 and the first water outlet fitting part are screwed connected.

For example, the housing 23 of the supporting arm assembly 2 may be provided with a first water outlet part 20, and the first water outlet part 20 may be a ball head or a joint, the second water outlet part may be a joint or a lock nut. The outer wall of the first water outlet part 20 may be provided with an external screw, and the inner wall of the second water outlet part may be provided with an internal screw, such that the first water outlet part 20 and the first water outlet fitting part are screwed connected, thus facilitating installation and disassembly of the first water outlet part 20 and the first water outlet fitting part. Meanwhile, the supporting arm assembly 2, the first water outlet part 20, the first water outlet fitting part, and the first shower head 3 are communicated to each other, so as to facilitate supplying spray water into the first shower head 3.

If it is required to adjust rotation angle of the first shower head 3 in respect to the supporting arm assembly 2, it is only necessary to adjust the angle of the first shower head 3 after turning the second water outlet part to loose.

The embodiment also provides a water outlet device including the above spraying mechanism.

In the water outlet device provided by this embodiment, since the supporting arm assembly 2 and the water inlet assembly 1 of the spraying mechanism, as well as the first shower head 3 and the supporting arm assembly 2, are not fixedly arranged, but movably arranged, by rotating the supporting arm assembly 2 in respect to the water inlet assembly 1, the first shower head 3 is rotated in respect to the supporting arm assembly 2, such that the first shower head 3 has multiple positions to meet the requirements of the users at different shower positions.

At the same time, the distance between the connection position between the first shower head 3 and the supporting arm assembly 2 and the position of the central axis of the first shower head 3 is not fixed, so the distance between the edge of the first shower head 3 and the connection position between the supporting arm assembly 2 and the first shower head 3 can be selected from two different distances, i.e. the first distance or the second distance, so as to adjust the relative position of the first shower head 3 in respect to the supporting arm assembly 2, thus diversifying shower modes to meet the diversified use requirements of users.

Another embodiment is disclosed that is similar to the first embodiment; a difference is the specific connection between the supporting arm assembly 2 and the first shower head 3.

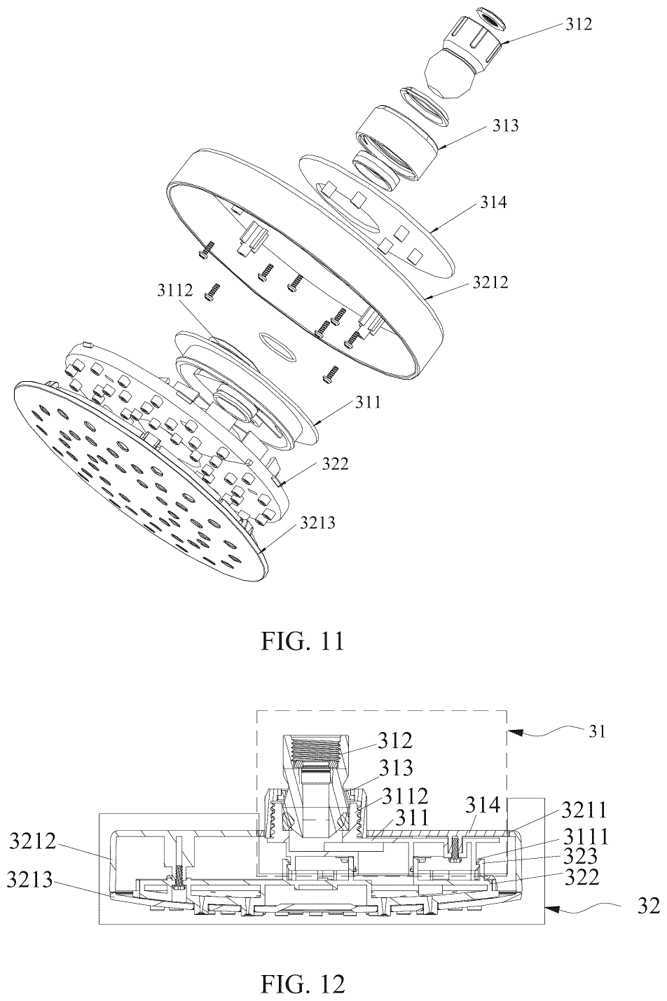

As shown in FIGS. 11-12, the first shower head 3 provided by this embodiment includes a first connecting assembly 31 and a second connecting assembly 32. One end of the first connecting assembly 31 is connected to the supporting arm assembly 2 and communicated to the supporting arm assembly 2, and the other end is connected to the second connecting assembly 32. The second connecting assembly 32 can be rotated in respect to the first connecting assembly 31.

Specifically, the first connecting assembly 31 is a fixed part, and the second connecting assembly 32 is a rotatable part. By dividing the first shower head 3 into two parts, i.e. the fixed part and the rotatable part, the first shower head 3 can realize relational rotation itself. Since the first connecting assembly 31 is connected to the supporting arm assembly 2, the first connecting assembly 31 and the supporting arm assembly 2 are fixed structures, that is, the first connecting assembly 31 only realizes intermediate connection between the supporting arm assembly 2 and the first shower head 3, and the second connecting assembly 32 realizes rotation of the first shower head 3 corresponding to the supporting arm assembly 2, so the supporting arm assembly 2 and the first shower head 3 realize separated arrangement of intermediate connection part and the rotatable part, so as to avoid the service life from being affected by excessive damage.

In an embodiment, as shown in FIGS. 11-12, the first connecting assembly 31 includes a mounting seat 311 and a first connecting part 312. The mounting seat 311 is at least partially arranged in the second connecting assembly 32, and the second connecting assembly 32 can be rotated in respect to the mounting seat 311. One end of the first connecting part 312 is connected to the supporting arm assembly 2, and the other end is arranged penetrating through the mounting seat 311 and connected to the mounting seat 311. The supporting arm assembly 2, the first connecting part 312, the mounting seat 311, and the second connecting assembly 32 are communicated to each other.

Among them, the first connecting part 312 may be a ball head, there may be a communication cavity in the first connecting part 312. The communication cavity is communicated to the supporting arm assembly 2 and the mounting seat 311. The mounting seat 311 may also be called a mounting and fixing base. The mounting seat 311 is at least partially located in the second connecting assembly 32, such that spray water flowing out of the supporting arm assembly 2 can be supplied to the second connecting assembly 32 through the first connecting part 312 for spraying.

In an embodiment, as shown in FIGS. 11-12, the first connecting assembly 31 further includes a fastener 313, and a protrusion 3112 is arranged protruding from a side of the mounting seat 311 facing the supporting arm assembly 2. The fastener 313 is sheathed outside the first connecting part 312 and the protrusion 3112, and is screwed connected to the protrusion 3112.

Among them, the protrusion 3112 of the mounting seat 311 is arranged protruding from the second connecting assembly 32, that is, the protrusion 3112 is exposed from the second connecting assembly 32, so as to facilitate connect the fastener 313 to the mounting seat 311 from the outside of the second connecting assembly 32. Among them, the fastener 313 may be a fixing nut, the internal screw of the fastener 313 and the external screw of the protrusion 3112 are screwed connected, and the fastener 313 is also sheathed outside the first connecting part 312 and abutted against the first connecting part 312, such that the first connecting part 312 can be fixed by using the fastener 313, so as to increase fixing effect between the first connecting part 312 and the mounting seat 311.

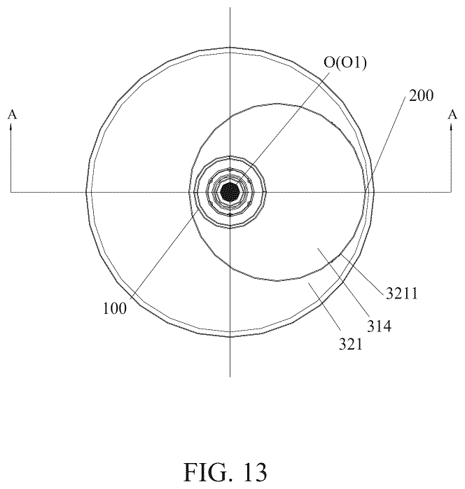

In an embodiment, as shown in FIGS. 12-13, the first connecting assembly 31 further includes a guiding member 314, and a side of the second connecting assembly 32 facing the supporting arm assembly 2 is provided with a guiding hole 3211. The guiding member 314 is sheathed outside the mounting seat 311 and is arranged in the guiding hole 3211. The second connecting assembly 32 can be rotated in respect to the guiding member 314, and the guiding hole 3211 and the guiding member 314 are cooperative in guiding.

Through mutual cooperation between the guiding member 314 and the guiding hole 3211, rotation path of the second connecting assembly 32 in respect to the first connecting assembly 31 can be planned, so as to realize cooperative guiding and ensure smooth rotation of the second connecting assembly 32.

Among them, the guiding member 314 has a cross section of circular structure, the guiding hole 3211 is a circular through hole. That is, the guiding member 314 may also be called a circular disk or turntable, and at this time circular, the disk or turntable is not rotatable, rather, the inner wall of the guiding hole 3211 is attached to the outer wall of the guiding member 314 and rotated along the outer wall of the guiding member 314, and contour of the outer wall of the guiding member 314 is the rotated path of the second connecting assembly 32. Since the guiding member 314 has a cross section of circular structure, the rotated path of the second connecting assembly 32 is the whole circumference, so rotation angle of the second connecting assembly 32 in respect to the first connecting assembly 31 is 360°, which is relatively large rotation range, thereby increasing rotation adjustment range of the first shower head 3.

In an embodiment, the projection of the central axis of the guiding member 314 in respect to the reference plane does not coincide with the projection of the central axis of the first shower head 3 in respect to the reference plane.

That is, the guiding member 314 and the first shower head 3 are eccentrically arranged, the second connecting assembly 32 is similar to a cam structure in rotation process, and the outer side part of the second connecting assembly 32 in respect to the supporting arm assembly 2 is variable, and effective spraying area may vary accordingly, so as to meet different spraying requirements of users.

In an embodiment, the diameter of the guiding member 314 is less than or equal to the diameter of the guiding hole 3211.

In this way, the guiding member 314 is just fitted inside the guiding hole 3211, and there is no relatively big gap between the guiding member 314 and the guiding hole 3211, thus avoiding occurrence of abnormal noise between the guiding member 314 and the guiding member 314 and ensuring smooth rotation of the second connecting assembly 32 in respect to the guiding member 314. At the same time, the guiding member 314 just covers the guiding hole 3211, and the guiding member 314 plays a role of obstructing to prevent external foreign matter from entering the first shower head 3 through a gap between the guiding member 314 and the guiding hole 3211. In addition, the guiding member 314 is equivalent to being embedded into the guiding hole 3211 of the second connecting assembly 32, so the overall external aesthetics is good.

When the first shower head 3 is in the first position 100, if the diameter of the guiding member 314 is less than or equal to the radius of the first shower head 3, the projection of the rotation center between the first shower head 3 and the supporting arm assembly 2 in respect to reference plane will not coincide with the projection of the central axis of the first shower head 3 in respect to the reference plane.

For this reason, the diameter of the guiding member 314 in the embodiment is larger than the radius of the first shower head 3, which is corresponding to the guiding member 314 at least covers or exceeds the central axis of the first shower head 3, so as to provide a space position for arranging the rotation center between the first shower head 3 and the supporting arm assembly 2.

If the diameter of the guiding member 314 is greater than or equal to the diameter of the first shower head 3, the edge of the guiding member 314 will be flush with the edge of the first shower head 3, or the edge of the guiding member 314 will exceed the edge of the first shower head 3, such that cooperative guiding of the second connecting assembly 32 cannot be realized.

For this reason, the diameter of the guiding member 314 is smaller than that of the first shower head 3, in other words, the second connecting assembly 32 with a relatively larger size is rotated around the guiding member 314 with a relatively smaller size, which can increase rotation adjustment range.

In an embodiment, as shown in FIGS. 11-13, the second connecting assembly 32 includes a shower head body 321, the mounting seat 311 is at least partially arranged in the shower head body 321, the guiding hole 3211 is arranged in the shower head body 321, and the shower head body 321 is rotatable in respect to the guiding member 314.

Among them, the shower head body 321 can be an integral structure or a split structure. The shower head body 321 includes a shower shroud 3212 and a decorative cover 3213. A side of the shower shroud 3212 away from the supporting arm assembly 2 is provided with an open end, and the decorative cover 3213 covers the open end, thus achieving good aesthetics. The guiding hole 3211 is arranged on the side of the shower shroud 3212 facing the supporting arm assembly 2, such that the shower head body 321 can be rotated in respect to the guiding member 314, the rotation adjustment range of the shower head body 321 can be ensured.

In an embodiment, the second connecting assembly 32 further includes a rainfall cover 322. The rainfall cover 322 is located in the shower head body 321 and connected to the shower head body 321.

Among them, the rainfall cover 322 can be directly welded with the shower head body 321, or connected to the shower head body 321 by bolts. For example, connecting posts may be arranged protruding from a side of the shower head body 321 facing the rainfall cover 322, and the bolts are arranged penetrating through the connecting posts and the rainfall cover 322, thus not only ensuring the fixed connection between the rainfall cover 322 and the shower head body 321, but also enabling the rainfall cover 322 being attached to the decorative cover 3213 as much as possible at the same time, so as to facilitate water flowing out of the water outlet of the rainfall cover 322. In addition, there is a certain space above the rainfall cover 322 to provide temporary storage space for spray water.

As shown in FIGS. 11-13, the rainfall cover 322 is at least partially annularly arranged around the mounting seat 311, and the rainfall cover 322 is rotated in respect to the mounting seat 311, thus ensuring rotational adjustment range of the rainfall cover 322.

It can be understood, the shower head body 321 of the second connecting assembly 32 is rotated in respect to the guiding member 314, and the rainfall cover 322 of the second connecting assembly 32 is rotated in respect to the mounting seat 311, so compared with the mode of being brought to rotate, both parts of the second connecting assembly 32 are rotated in respect to the first connecting assembly 31, which further improves smoothness of the second connecting assembly 32 in the process of rotation adjustment.

In an embodiment, one side of the rainfall cover 322 and the mounting seat 311 close to each other is provided with a limit hook 323, and the other side is provided with a limit clasp 3111. The limit hook 323 hooks onto the limit clasp 3111, and the limit hook 323 and the limit clasp 3111 can be rotated in respect to each other.

That is, a mechanical claw is adopted between the rainfall cover 322 and the mounting seat 311, which can achieve position limit between the rainfall cover 322 and the mounting seat 311 to a certain extent, and rotation cooperation between them is not affected.

It should be understood, the disclosure is not limited to the precise structure described above and shown in the drawings, and various modifications and changes can be made without departing from its scope. The protection scope of the disclosure is limited only by the appended claims.

### LIST OF REFERENCE SIGNS

100: First Position; 200: Second Position;
1: Water Inlet Assembly; 2: Supporting Arm Assembly; 3: First Shower Head; 4: Limiting Assembly; 5: Second Shower Head; 6: Switching Assembly; 7: Sealing Member; 8: Plug; 9: Magnetic Attraction Assembly; 10: Shower Joint;
11: Fixed Seat; 111: Water Inlet Channel; 112: Communication Port; 113: First Water outlet; 114: Second Water Outlet; 115: Accommodating Groove; 12: Fixed Body; 13: Water-saving Sheet; 14: Screen Gasket; 15: Spherical Joint; 16: Bushing; 17: Nut; 18: Spherical Sealing Gasket; 19: First Spacer;
20: First Water Outlet Part; 21: Sleeve; 22: Supporting Arm; 23: Housing; 230: Limiting Holes; 231: First Housing; 232: Second Housing;
41: elastic Member; 42: Limiting Member;
31: First Connecting Assembly; 32: Second Connecting Assembly;
311: Mounting Seat; 3111: Limit Clasp; 3112: Protrusion; 312: First Connecting Part; 313: Fastener; 314: Guiding Member;
321: Shower Head Body; 3211: Guiding Hole; 3212: Shower Shroud; 3213: Decorative Cover;
322: rainfall Cover; 323: Limit Hook;
61: Switching Shaft; 611: Holding Part; 612: Obstructing Part; 62: Handle;
71: First Through Hole; 72: Second Through Hole;
91: Magnet Bracket; 92: Cushion Block; 93: Second Spacer; 94: Magnetic Attraction Member.

What is claimed is:

1. A spraying mechanism, wherein the spraying mechanism comprises:
a water inlet assembly, provided with a water inlet channel;
a supporting arm assembly, connected to the water inlet assembly and rotatable in respect to the water inlet assembly; and
a first shower head, communicated to the water inlet channel through the supporting arm assembly, the first shower head is connected to the supporting arm assembly and rotatable in respect to the supporting arm assembly, there is at least a first distance and a second distance between a projection of a connection position between the first shower head and the supporting arm assembly in respect to a reference plane and a projection of a central axis of the first shower head in respect to the reference plane, and the first distance is not equal to the second distance;
wherein the reference plane is perpendicular to the central axis of the first shower head.

2. The spraying mechanism according to claim 1, wherein when the first distance between a projection of a rotation center between the first shower head and the supporting arm assembly in respect to the reference plane and the projection of the central axis of the first shower head in respect to the reference plane is zero, the connection position between the first shower head and the supporting arm assembly is a first position;
when a distance between the projection of the rotation center between the first shower head and the supporting arm assembly in respect to the reference plane and the projection of the central axis of the first shower head in respect to the reference plane is the second distance, the connection position between the first shower head and the supporting arm assembly is a second position;
wherein a distance between the first position and the second position is less than or equal to a radius of the first shower head.

3. The spraying mechanism according to claim 1, wherein the water inlet assembly comprises:
a fixed seat, the supporting arm assembly is sheathed outside the fixed seat and rotatable in respect to the fixed seat, a circumferential side wall of the fixed seat is provided with a communication port, the water inlet channel is arranged in the fixed seat, and the water inlet channel is communicated to the supporting arm assembly through the communication port.

4. The spraying mechanism according to claim 3, wherein the spraying mechanism further comprises a limiting assembly, and the limiting assembly is arranged between the fixed seat and the supporting arm assembly for position limiting between the fixed seat and the supporting arm assembly, and
wherein the limiting assembly comprises an elastic member and a limiting member, one of an outer wall of the fixed seat and an inner wall of the supporting arm assembly is provided with an accommodating groove, and the other is provided with a plurality of limiting holes along a circumferential direction of the fixed seat, the elastic member is arranged in the accommodating groove, one end of the limiting member abuts against the elastic member and the other end is able to be arranged penetrating through one of the limiting holes.

5. The spraying mechanism according to claim 1, wherein one side of the supporting arm assembly and the first shower head facing each other is provided with a first water outlet part, and the other side is provided with a first water outlet fitting part, the first water outlet part and the first water outlet fitting part are screwed connected, and the supporting arm assembly, the first water outlet part, the first water outlet fitting part, and the first shower head are communicated to each other.

6. The spraying mechanism according to claim 1, wherein the first shower head comprises a first connecting assembly and a second connecting assembly, one end of one end of the first connecting assembly is connected to the supporting arm assembly and communicated to the supporting arm assembly, and the other end is connected to the second connecting assembly, and the second connecting assembly is rotatable in respect to the first connecting assembly.

7. The spraying mechanism according to claim 6, wherein the first connecting assembly comprises:
a mounting seat, at least partially arranged in the second connecting assembly, and the second connecting assembly is rotated in respect to the mounting seat; and
a first connecting part, one end is connected to the supporting arm assembly, and the other end is arranged penetrating through the mounting seat and connected to the mounting seat, and the supporting arm assembly, the first connecting part, the mounting seat, and the second connecting assembly are communicated to each other.

8. The spraying mechanism according to claim 7, wherein the first connecting assembly further comprises a fastener, a side of the mounting seat facing the supporting arm assembly is provided with a protrusion arranged protruding, and the fastener is sheathed outside the first connecting part and the protrusion and screwed connected to the protrusion.

9. The spraying mechanism according to claim 7, wherein the first connecting assembly further comprises:
a guiding member, one side of the second connecting assembly facing the supporting arm assembly is provided with a guiding hole, the guiding member is sheathed outside the mounting seat and is arranged in the guiding hole, the second connecting assembly is rotated in respect to the guiding member, and the guiding hole and the guiding member are cooperative in guiding.

10. The spraying mechanism according to claim 9, wherein the guiding member has a cross section of circular structure, and the guiding hole is a circular through hole; and
a projection of a central axis of the guiding member in respect to the reference plane and the projection of the central axis of the first shower head in respect to the reference plane are not coincident.

11. The spraying mechanism according to claim 10, wherein a diameter of the guiding member is less than or equal to a diameter of the guiding hole;
and the diameter of the guiding member is larger than a radius of the first shower head, and the diameter of the guiding member is smaller than a diameter of the first shower head.

12. The spraying mechanism according to claim 9, wherein the second connecting assembly comprises:
a shower head body, the mounting seat is at least partially arranged in the shower head body, the guiding hole is arranged in the shower head body, and the shower head body is rotated in respect to the guiding member; and
a rainfall cover, located in the shower head body and connected to the shower head body, the rainfall cover is annularly arranged around the mounting seat, and the rainfall cover is rotated in respect to the mounting seat.

13. The spraying mechanism according to claim 12, wherein one side of the rainfall cover and the mounting seat close to each other is provided with a limit hook, and the other side is provided with a limit clasp, the limit hook hooks onto the limit clasp, and the limit hook and the limit clasp are rotatable in respect to each other.

14. The spraying mechanism according to claim 1, wherein the spraying mechanism further comprises:
a wall seat; and
a second shower head, connected to the water inlet assembly and able to be communicated to the water inlet channel;
wherein the second shower head is detachably connected to one of the water inlet assembly and the wall seat.

15. The spraying mechanism according to claim 14, wherein the water inlet assembly comprises a fixed seat, the supporting arm assembly is sheathed outside the fixed seat and rotatable in respect to the fixed seat, and the water inlet channel is arranged in the fixed seat;
wherein the fixed seat is provided with a first water outlet and second water outlet, the first water outlet is communicated to the supporting arm assembly, the second water outlet is communicated to the second shower head, and the water inlet channel is selectively communicated to one of the first water outlet and the second water outlet.

16. The spraying mechanism according to claim 15, wherein the spraying mechanism further comprises a switching assembly, the switching assembly includes a switching shaft, and one end of the switching shaft is provided with a holding part, and the other end is provided with an obstructing part; and
wherein the switching shaft is arranged penetrating through the fixed seat and rotated in respect to the fixed seat, such that the obstructing part is able to selectively obstruct one of the first water outlet and the second water outlet.

17. The spraying mechanism according to claim 16, wherein the spraying mechanism further comprises a sealing member, the sealing member is arranged in the water inlet channel, and the sealing member is wrapped on at least part of the obstructing part and arranged between the obstructing part and the fixed seat; and
the sealing member is provided with a first through hole and a second through hole, the first through hole is arranged corresponding to the first water outlet and communicated to the first water outlet, and the second through hole is arranged corresponding to the second water outlet and communicated to the second water outlet.

18. The spraying mechanism according to claim 15, wherein the spraying mechanism further comprises a plug, the plug is arranged inside an end of the water inlet channel close to the supporting arm assembly.

19. The spraying mechanism according to claim 1, wherein the supporting arm assembly comprises: and
a sleeve, sheathed outside the water inlet assembly and rotatable in respect to the water inlet assembly;
a supporting arm, one end of the supporting arm is connected to the sleeve and communicated to the water inlet channel, and the other end of the supporting arm is rotatably connected to the first shower head and communicated to the first shower head.

20. A water outlet device, wherein the water outlet device comprises the spraying mechanism according to claim 1.
